(19) United States
(12) Patent Application Publication
(10) Pub. No.: US 2024/0096229 A1
(43) Pub. Date: Mar. 21, 2024

(54) INFORMATION PROCESSING APPARATUS, INFORMATION OUTPUT METHOD, AND RECORDING MEDIUM

(71) Applicant: CASIO COMPUTER CO., LTD., Tokyo (JP)

(72) Inventor: Takuya AKO, Tachikawa-shi (JP)

(73) Assignee: CASIO COMPUTER CO., LTD., Tokyo (JP)

(21) Appl. No.: 18/366,718

(22) Filed: Aug. 8, 2023

(30) Foreign Application Priority Data
Sep. 15, 2022 (JP) 2022- 147281

(51) Int. Cl. G09B 5/02

(52) U.S. Cl. CPC G09B 5/02

(57) ABSTRACT

An information processing apparatus according to an aspect includes a processor. The processor acquires first and second history information from a storage unit that stores learning information on a plurality of users, the learning information being information for specifying an activation date of teaching material data and the teaching material data for the plurality of users as the first history information, and information for specifying an execution date of a test and the test and results of the test for the plurality of users as the second history information. The processor extracts learning information in which a result of the test satisfies a predetermined condition and in which an activation date of teaching material data is earlier than the execution date of the test, based on the acquired first and second history information. The processor outputs information for specifying the teaching material data.

### CROSS-REFERENCE TO RELATED APPLICATION

This application is based upon and claims the benefit of priority from the Japanese Patent Application No. 2022-147281, filed Sep. 15, 2022, the entire contents of which are incorporated herein by reference.

### FIELD

The disclosure relates to an information processing apparatus, an information output method, and a recording medium.

### BACKGROUND

In recent years, electronic devices such as electronic dictionaries are configured to be capable of storing various teaching material data for supporting learning such as reference book data in addition to dictionary data. Further, as described in Jpn. Pat. Appln. KOKAI Publication No. 2012-208143, there is also an electronic device having a function of adding teaching material data.

### SUMMARY

An information processing apparatus according to an aspect includes a processor. The processor acquires first history information and second history information from a storage unit that stores learning information on a plurality of users, the learning information being information for specifying an activation date of teaching material data and the teaching material data for the plurality of users as the first history information, and information for specifying an execution date of a test and the test and results of the test for the plurality of users as the second history information. The processor extracts, from the learning information stored in the storage unit, learning information in which a result of the test satisfies a predetermined condition and in which an activation date of teaching material data is earlier than the execution date of the test, based on the acquired first history information and the acquired second history information. The processor outputs information for specifying the teaching material data, included in the extracted learning information.

### BRIEF DESCRIPTION OF THE DRAWINGS

FIG. 1 is a diagram illustrating an example of a configuration of a system according to an embodiment.

FIG. 2 is a diagram illustrating a detailed configuration of the system.

FIG. 3 is a diagram illustrating an example of learning information 143.

FIG. 4 is a diagram illustrating an example of learning information 244.

FIG. 5 is a flowchart illustrating an operation of a server.

FIG. 6 is a flowchart illustrating an operation of an electronic dictionary.

FIG. 7 is a diagram illustrating an example of a top screen.

FIG. 8 is a flowchart illustrating an example of a suggestion process.

FIG. 9 is a diagram illustrating an example of a suggestion top screen.

FIG. 10 is a diagram illustrating an example of a suggestion screen.

FIG. 11 is a flowchart illustrating a teaching material extraction process.

### DETAILED DESCRIPTION

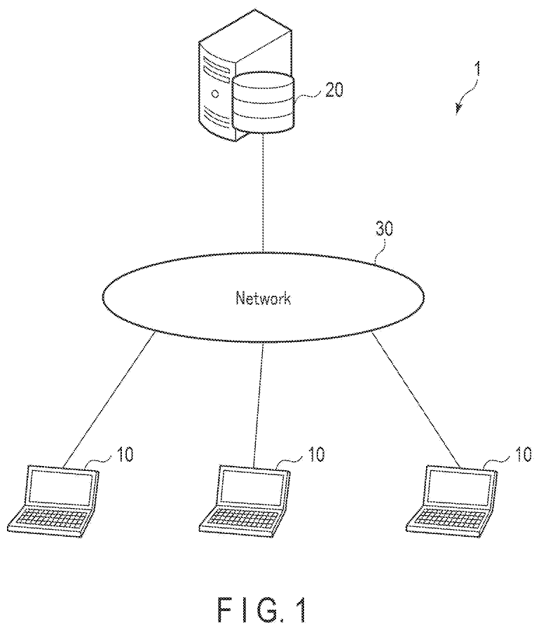

Hereinafter, embodiments will be described with reference to the drawings. FIG. 1 is a diagram illustrating an example of a configuration of a system 1 according to an embodiment. The system 1 includes an electronic dictionary 10 and a server 20. The electronic dictionary 10 and the server 20 are communicably connected to each other via a network 30. The network 30 is, for example, the Internet. Although FIG. 1 illustrates three electronic dictionaries 10, the number of electronic dictionaries 10 is not limited to three. In the embodiment, it is assumed that the three electronic dictionaries 10 are used by different users.

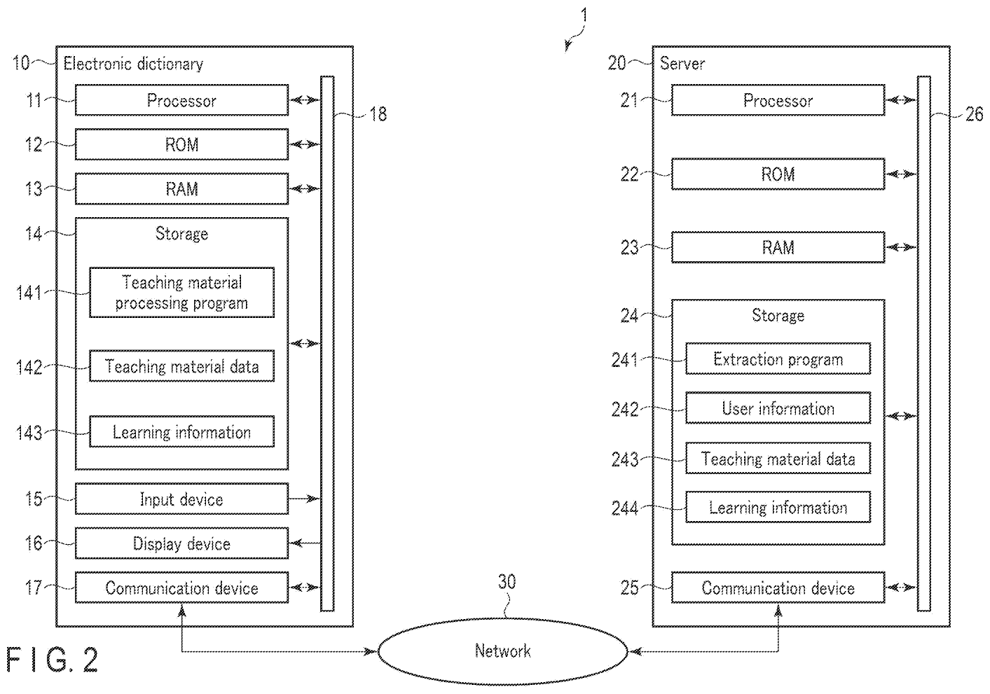

FIG. 2 is a diagram illustrating a detailed configuration of the system 1. Here, FIG. 2 illustrates one electronic dictionary 10 as a representative. The electronic dictionary 10 includes a processor 11, a ROM 12, a RAM 13, a storage 14, an input device 15, a display device 16, and a communication device 17. These devices are connected to each other via a system bus 18. The electronic dictionary 10 may be an electronic device such as a personal computer (PC), a tablet terminal, or a smartphone in which an electronic dictionary application is installed.

The processor 11 controls various operations of the electronic dictionary 10. The processor 11 may be an integrated circuit including a central processing unit (CPU) and the like. As the processor 11, a processor other than a CPU, for example, an application specific integrated circuit (ASIC), a field programmable gate array (FPGA), a graphic processing unit (GPU), or the like may be used.

The ROM 12 stores a program for starting the electronic dictionary 10, and the like. The RAM 13 is a main storage device for the processor 11 and the like.

The storage 14 can operate as a storage unit. The storage 14 stores various programs such as an electronic dictionary control program used by the processor 11, parameters, and the like. The processor 11 controls the operation of the electronic dictionary 10 by executing various programs according to an input signal or the like from the input device 15. The various programs include, for example, a teaching material processing program 141. The teaching material processing program 141 is a program for executing various types of processing on content included in teaching material data 142 based on an instruction of a user. The teaching material processing program 141 can be, for example, a program for executing processing of displaying the content included in the teaching material data 142 on the display device 16 and processing of returning a response to an instruction from the user for the displayed content.

The teaching material data 142 is various content data used for learning by the user, such as dictionary data and reference book data. For example, the dictionary data is content data in which phrases such as words in dictionaries such as a Japanese dictionary and an English-Japanese dictionary and meanings thereof are stored in association with each other. The reference book data is content data in which simple worksheet data for explanation or the like of a textbook or confirmation of understanding is stored. In addition, the teaching material data 142 includes test data. The test data is content data for executing various tests. The test data may be generated with reference to the worksheet data. The teaching material data 142 may be added by being downloaded from the server 20, for example.

Furthermore, in the embodiment, learning information 143 is stored in the storage 14. The learning information 143 is information of a history of learning performed by the user using the electronic dictionary 10. In the embodiment, the history of the learning includes histories of activation of the dictionary data, the reference book data, the worksheet data, and the like as learning for improving the own academic ability, and a history that is based on the test data and is a history of executing a test as learning for confirming the one's current academic ability.

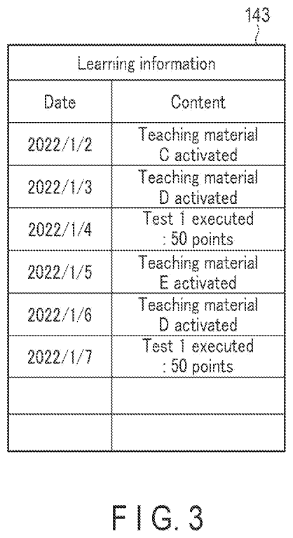

FIG. 3 is a diagram illustrating an example of the learning information 143. The learning information 143 includes information of a “date” and “content”. The “date” is information of a date on which learning is carried out. The “content” is information indicating the content of the learning. The content of the learning includes information such as information for specifying teaching material data activated by the user, information that is based on the test data and is information for specifying a test performed by the user, and a result of the test. The information for specifying the teaching material data is, for example, a name of the teaching material data. In addition, the information for specifying the test is, for example, a name of the test. The learning information 143 is updated if the teaching material data 142 is activated. Alternatively, the learning information 143 is updated if a test is executed and scoring is completed. For example, in a case where a “teaching material A” is used as the teaching material data 142, an activation date of the teaching material data 142 is recorded as information of a “date”, and the name “teaching material A” of the activated teaching material data 142 is recorded as information of “content”. Furthermore, for example, in a case where a “test 1” is executed using the teaching material data 142, the execution date of the test 1 is recorded as information of a “date”, and the name “test 1” of the executed test is recorded as information of “content” together with a scoring result at that time. Here, the learning information 143 may be stored for each of the users of the electronic dictionaries 10. In this case, the learning information 143 is stored in association with, for example, IDs of the users of the electronic dictionaries 10.

The input device 15 includes an input key, a touch panel, and the like. Furthermore, the input device 15 may include a sound input device such as a microphone. In response to a user operation via the input device 15, a signal indicating the content of the user operation is input to the processor 11 via the system bus 18.

The display device 16 is a liquid crystal display, an organic EL display, or the like. The display device 16 may be provided integrally with the electronic dictionary 10 or may be provided separately from the electronic dictionary 10. Various images are displayed on the display device 16.

The communication device 17 includes a circuit for communicating with an external communication network such as the network 30. The communication device 17 can operate as a communication unit.

The server 20 is an information processing apparatus including a processor 21, a ROM 22, a RAM 23, a storage 24, and a communication device 25. These devices are connected to each other via a system bus 26.

The processor 21 controls various operations of the server 20. The processor 21 may be an integrated circuit including a CPU and the like. As the processor 21, a processor other than a CPU, for example, an ASIC, an FPGA, a GPU, or the like may be used.

The ROM 22 records information used for the operation of the processor 21 and the like. The RAM 23 is a main storage device for the operation of the processor 21 and the like.

The storage 24 stores various programs such as a server control program used by the processor 21, parameters, and the like. The processor 21 controls the operation of the server 20 by executing various programs. The various programs include, for example, an extraction program 241. The extraction program 241 is a program for executing processing of extracting teaching material data useful for learning by the user from the teaching material data 142 stored in the electronic dictionary 10 or from teaching material data different from the teaching material data 142. The processor 21 can operate as a control unit by executing processing according to the extraction program 241.

In addition, the storage 24 stores user information 242, teaching material data 243, and learning information 244.

The user information 242 is information for identifying the users of the electronic dictionaries 10. The user information 242 can include, for example, information indicating IDs of the users, IDs of the electronic dictionaries 10, and attributes of the users, such as the ages of the users.

The teaching material data 243 is various content data that can be downloaded to the electronic dictionaries 10 and used, such as the dictionary data, the reference book data, the worksheet data, and the test data. The teaching material data 243 may include more content data than the teaching material data 142 stored in advance in the electronic dictionaries 10.

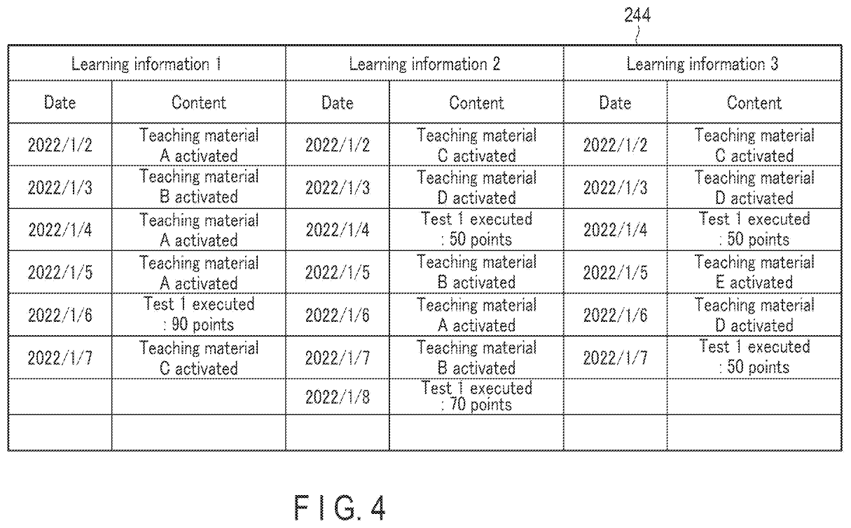

The learning information 244 is learning information collected from the plurality of electronic dictionaries 10. FIG. 4 is a diagram illustrating an example of the learning information 244. For example, an ID (identification information) for management is assigned to each piece of learning information collected from the electronic dictionaries 10 as the learning information 244. FIG. 4 illustrates an example in which three pieces of learning information are stored. FIG. 4 illustrates that IDs of the three pieces of learning information are “learning information 1”, “learning information 2”, and “learning information 3”. The information collected as the learning information may be the same as the learning information 143 stored in the electronic dictionaries 10. In this case, the learning information 244 may be stored for each of users of the electronic dictionaries 10. In this case, different IDs are assigned as different learning information to learning information of different users collected from the same electronic dictionary 10. Furthermore, as the learning information 244, information of aggregate results of the learning information collected from the plurality of electronic dictionaries 10 may be further stored. The information of the aggregate results may include, for example, information such as the number of times of use of the same teaching material data used within a certain period and an average value of scores of the same test executed within a certain period.

The communication device 25 includes a circuit for communicating with an external communication network such as the network 30. The communication device 25 can operate as a communication unit.

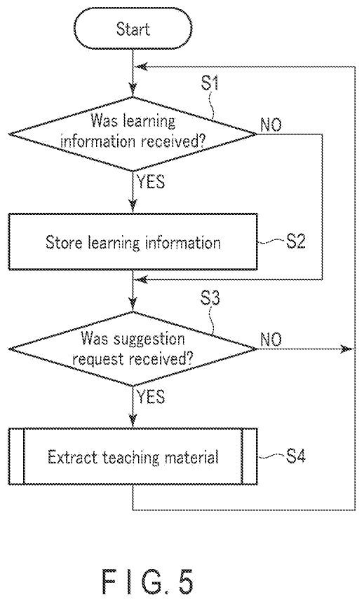

Next, an operation of the system 1 will be described. FIG. 5 is a flowchart illustrating an operation of the server 20. A process illustrated in FIG. 5 is periodically started while the server 20 is in operation.

In step S1, the processor 21 of the server 20 determines whether or not learning information was received from the electronic dictionary 10. In a case where it is determined in step S1 that the learning information was received, the process proceeds to step S2. In a case where it is not determined in step S1 that the learning information was received, the process proceeds to step S3.

In step S2, the processor 21 stores the learning information received from the electronic dictionary 10 to the storage 24. In a case where the corresponding learning information is already stored in the storage 24, the processor 21 overwrites the original learning information with the learning information received from the electronic dictionary 10. On the other hand, in a case where the corresponding learning information is not stored in the storage 24, the processor 21 newly stores the learning information received from the electronic dictionary 10 to the storage 24. Note that the learning information 244 stored in the storage 24 may be erased after a certain period of time elapses. Of course, the learning information 244 stored in the storage 24 may not be erased after the certain period of time elapses. Furthermore, as described above, the learning information may be managed for each user. In this case, the processor 21 stores the learning information for each user based on the user ID associated with the learning information received from the electronic dictionary 10 and the user IDs stored in the user information 242.

In step S3, the processor 21 determines whether or not a request to suggest teaching material data was received. The request to suggest the teaching material data is transmitted from the electronic dictionary 10, for example. The request to suggest the teaching material data may be transmitted from an electronic device other than the electronic dictionary 10, that is, an electronic device having no electronic dictionary function. In a case where it is determined in step S3 that the request to suggest the teaching material data was received, the process proceeds to step S4. In a case where it is not determined in step S3 that the request to suggest the teaching material data was received, the process returns to step S1.

In step S4, the processor 21 performs a teaching material extraction process. After the teaching material extraction process, the process returns to step S1. The teaching material extraction process is a process of extracting teaching material data useful for learning by the user. The teaching material extraction process will be described later.

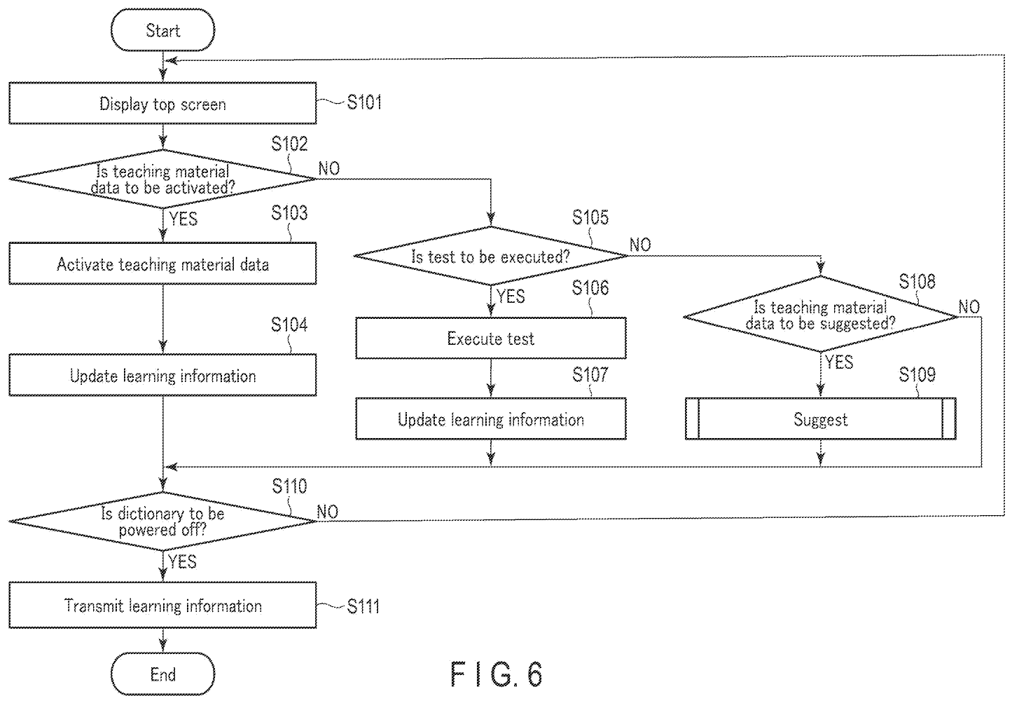

FIG. 6 is a flowchart illustrating an operation of the electronic dictionary 10. The operation illustrated in FIG. 6 is started every time the electronic dictionary 10 is powered on, for example. In step S101, the processor 11 of the electronic dictionary 10 displays a top screen of the electronic dictionary 10 on the display device 16.

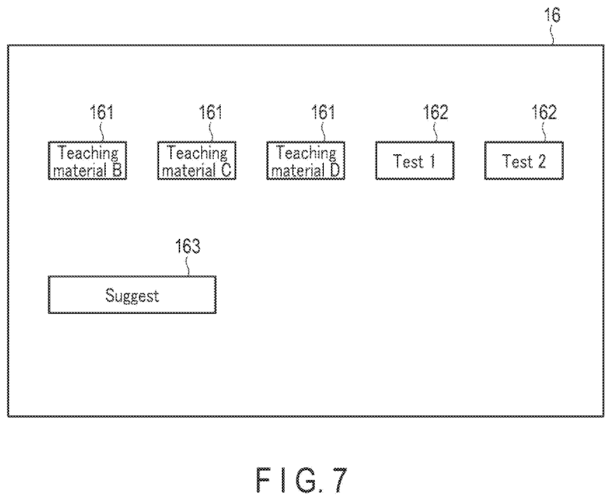

FIG. 7 is a diagram illustrating an example of the top screen. Buttons and the like other than those illustrated in FIG. 7 may be displayed on the top screen.

On the top screen as an example, a list 161 of teaching material data recorded as the teaching material data 142 of the electronic dictionary 10 is displayed. The user can select teaching material data that the user wants to use from the list 161 of teaching material data. In addition, a list 162 of tests that can be executed based on the teaching material data 142 of the electronic dictionary 10 is displayed on the top screen as an example. The user may select a test that the user wants to take from the list 162 of tests. Further, a suggest button 163 is displayed on the top screen as an example. The suggest button 163 is a button selected by the user in a case where a suggestion of teaching material data useful for the learning by the user is received from the electronic dictionary 10.

In step S102, the processor 11 determines whether or not to activate the teaching material data. For example, in a case where one teaching material data piece in the list 161 of teaching material data is selected by the user, it is determined to activate the teaching material data. In a case where it is determined in step S102 that the teaching material data is to be activated, the process proceeds to step S103. In a case where it is not determined in step S102 that the teaching material data is to be activated, the process proceeds to step S105.

In step S103, the processor 11 activates the teaching material data selected by the user. Thereafter, the processor 11 performs processing corresponding to the activated teaching material data. After the activated teaching material data ends, the process proceeds to step S104. For example, if the dictionary data is activated, the processor 11 displays the top screen of the activated dictionary on the display device 16, searches the dictionary data for a term corresponding to a search word input by the user thereafter, and displays a search result on the display device 16. In addition, in a case where the reference book data is activated, the explanation or the like of the textbook stored as the reference book data is displayed according to an operation of the user. Furthermore, in a case where the worksheet data is activated, problems of various subjects are displayed according to an operation of the user, and if answers to the problems are input by the user, the answers are compared with correct answers stored in advance for the problem, and an explanation is displayed. Thereafter, an instruction to end the display of the teaching material data is received from the user, and the process proceeds to step S104.

In step S104, the processor 11 updates the learning information 143. Thereafter, the process proceeds to step S110. Specifically, the processor 11 registers the name of the activated teaching material data in the learning information 143 together with the activation date.

In step S105, the processor 11 determines whether or not to execute a test. For example, in a case where one test in the list 162 of tests is selected by the user, it is determined to execute the test. In a case where it is determined in step S105 that the test is to be executed, the process proceeds to step S106. In a case where it is not determined in step S105 that the test is to be executed, the process proceeds to step S108.

In step S106, the processor 11 activates test data included in the teaching material data selected by the user, and executes the test. After the test ends, the process proceeds to step S107. For example, the processor 11 displays a test question on the display device 16 together with an answer field based on the selected test data. After the end of the test time or in a case where the user instructs the end of the test, the processor 11 executes scoring. The scoring may be executed by a device outside the electronic dictionary 10, such as the server 20, for example. After executing the scoring, the processor 11 displays a result of the scoring on the display device 16. Thereafter, if the processor 11 receives an instruction to end the test from the user, the process proceeds to step S107.

In step S107, the processor 11 updates the learning information 143. Thereafter, the process proceeds to step S110. Specifically, the processor 11 registers the name of the executed test and the scoring result at that time in the learning information 143 together with the execution date of the test.

In step S108, the processor 11 determines whether or not to suggest teaching material data. For example, in a case where the suggest button 163 is selected by the user, it is determined to suggest the teaching material data. In a case where it is determined in step S108 that the teaching material data is to be suggested, the process proceeds to step S109. In a case where it is not determined in step S108 that the teaching material data is to be suggested, the process proceeds to step S110.

In step S109, the processor 11 performs the suggestion process. After the suggestion process ends, the process proceeds to step S110. The suggestion process is a process of suggesting the teaching material data extracted by the server 20 as recommended teaching material data for the user. The suggestion process will be described later.

In step S110, the processor 11 determines whether or not to power off the electronic dictionary 10. For example, if the power button of the electronic dictionary 10 is pressed by the user, it is determined to power off the electronic dictionary 10. In a case where it is determined in step S110 that the electronic dictionary 10 is to be powered off, the process proceeds to step S111. In a case where it is not determined in step S110 that the electronic dictionary 10 is to be powered off, the process returns to step S101.

In step S111, the processor 11 transmits the learning information to the server 20. Thereafter, the process illustrated in FIG. 6 ends. In this case, the transmission of the learning information may not be necessarily performed immediately before the electronic dictionary 10 is powered off. The transmission of the learning information may be performed, for example, at a timing of updating the learning information, at a predetermined time such as the night of each day, or immediately after the electronic dictionary 10 is powered on.

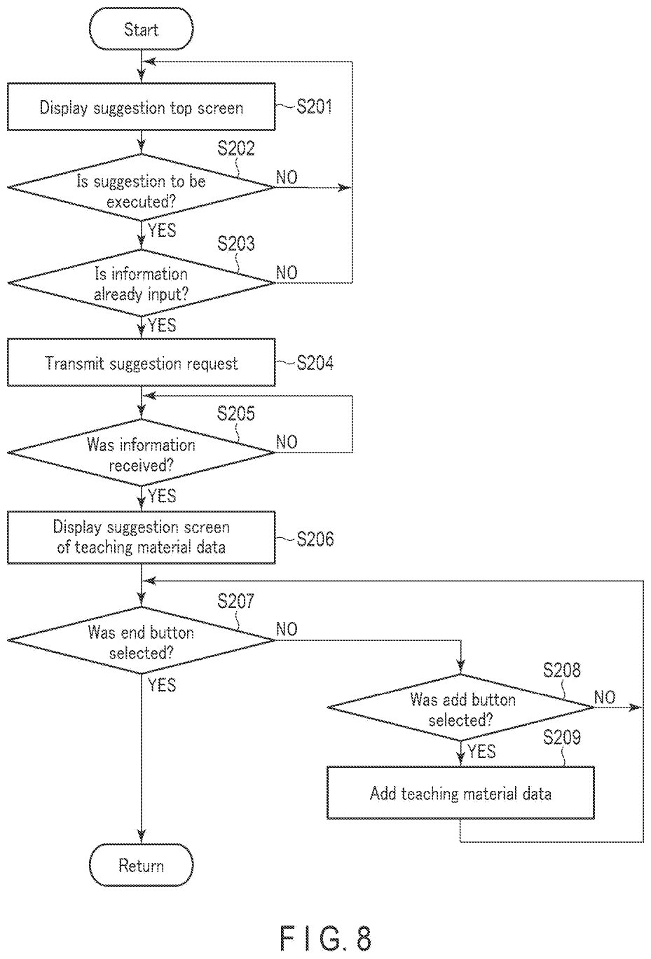

FIG. 8 is a flowchart illustrating an example of the suggestion process. In step S201, the processor 11 of the electronic dictionary 10 displays a suggestion top screen on the display device 16.

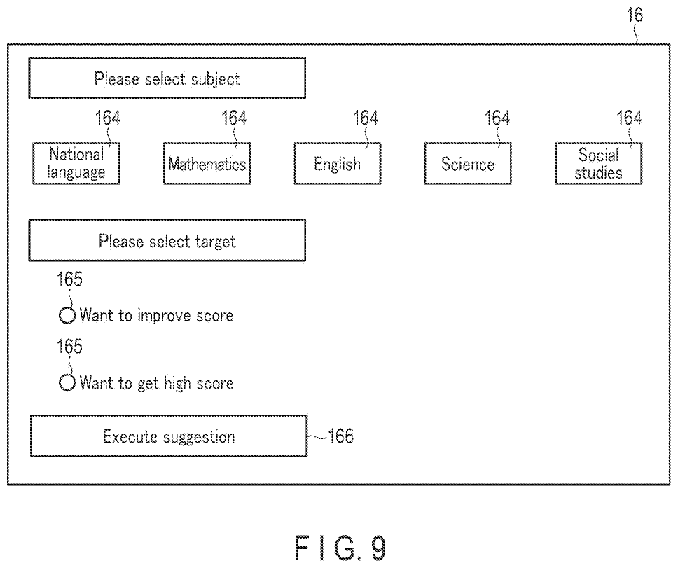

FIG. 9 is a diagram illustrating an example of the suggestion top screen. Buttons and the like other than those illustrated in FIG. 9 may be displayed on the suggestion top screen.

On the suggestion top screen as an example, a list 164 of subjects for which suggestions of teaching material data are desired to be received is displayed. The user can select a subject for which the user wants to receive a suggestion from the list 164 of subjects. In this case, in FIG. 9, the list 164 of subjects is displayed. A list of tests may be displayed instead of the list 164 of subjects. In this case, the user may select a test that the user wants to improve the user's score. Furthermore, in a case where the list of subjects is selected, a list of specific learning items for which a suggestion of teaching material data is desired to be received may be displayed. For example, in a case where “mathematics” is selected as a subject, a list of learning items for each subject such as “quadratic function” and “factorization” may be displayed. In this case, the user can select a subject for which the user wants to receive a suggestion from the list 164 of subjects and further select a learning item thereafter.

Furthermore, on the suggestion top screen as an example, a target selection field 165 for a target of the user's own learning is displayed. The user can select a target close to the target of the user's own learning from the target selection field 165. For example, in FIG. 9, the user can select a target close to a user's own target from two options of “want to improve the score” and “want to get a high score”. In this case, the targets displayed in the target selection field 165 are not limited to the two targets illustrated in FIG. 9.

In addition, an execute suggestion button 166 is displayed on the suggestion top screen as an example. The execute suggestion button 166 is a button selected by the user to instruct the execution of the suggestion of teaching material data.

In step S202, the processor 11 determines whether or not to execute the suggestion. For example, if the execute suggestion button 166 is selected, it is determined to execute the suggestion. In a case where it is not determined in step S202 that the suggestion is to be executed, the process returns to step S201. During this period, the user can select a subject for which the user wants to receive a suggestion from the list 164 of subjects, and select a target close to the target of the user's own learning from the target selection field 165. In a case where it is determined in step S202 that the suggestion is to be executed, the process proceeds to step S203.

In step S203, the processor 11 determines whether or not information necessary for executing the suggestion is already input. For example, in a case where information of a subject and information of the target of learning are already input on the suggestion top screen illustrated in FIG. 9, it is determined that the information necessary for executing the suggestion is already input. In a case where it is determined in step S203 that the information necessary for executing the suggestion is already input, the process proceeds to step S204. In a case where it is not determined in step S203 that the information necessary for executing the suggestion is already input, the process returns to step S201. In this case, the processor 11 may display a message for prompting the user to input information on the display device 16.

In step S204, the processor 11 transmits a suggestion request to the server 20. The suggestion request includes, for example, information for specifying the electronic dictionary 10 or the user, information of a subject input by the user, and information of a target of learning input by the user.

In step S205, the processor 11 determines whether or not the suggestion information was received from the server 20. The suggestion information includes information for specifying teaching material data extracted in the server 20. In step S205, the processor 11 waits until the suggestion information is received from the server 20. In a case where it is determined in step S205 that the suggestion information was received from the server 20, the process proceeds to step S206.

In step S206, the processor 11 displays a suggestion screen of the teaching material data on the display device 16 based on the suggestion information received from the server 20.

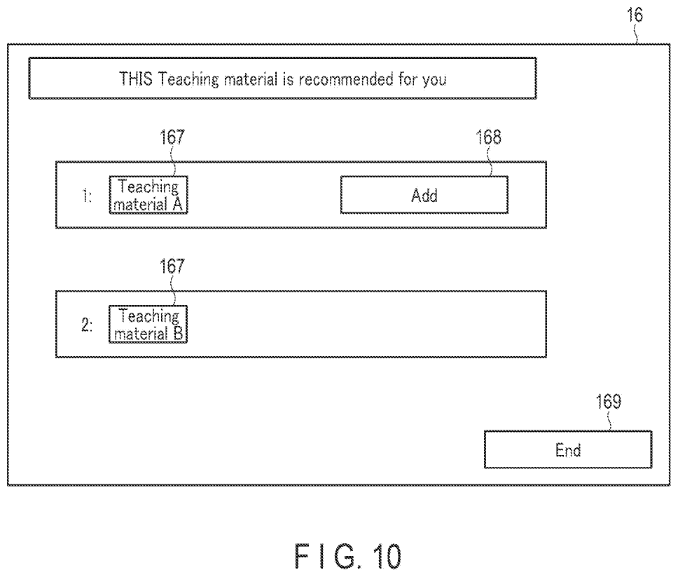

FIG. 10 is a diagram illustrating an example of the suggestion screen. Buttons and the like other than those illustrated in FIG. 10 may be displayed on the suggestion screen.

On the suggestion screen as an example, a list 167 of teaching material data extracted by the server 20 is displayed. As will be described later, the teaching material data extracted by the server 20 may include teaching material data recorded in the electronic dictionary 10 and teaching material data that is not recorded. For the teaching material data not recorded in the electronic dictionary 10, an add button 168 is displayed. The add button 168 is a button selected by the user to add teaching material data.

In addition, an end button 169 is displayed on the suggestion screen as an example. The end button 169 is a button selected by the user to end the display of the suggestion screen.

In step S207, the processor 11 determines whether or not the end button 169 was selected. In a case where it is determined in step S207 that the end button 169 was selected, the process illustrated in FIG. 8 ends. In this case, the process proceeds to step S110 illustrated in FIG. 6. In a case where it is not determined in step S207 that the end button 169 was selected, the process proceeds to step S208.

In step S208, the processor 11 determines whether or not the add button 168 was selected. In a case where it is determined in step S208 that the add button 168 was selected, the process proceeds to step S209. In a case where it is not determined in step S208 that the add button 168 was selected, the process returns to step S207.

In step S209, the processor 11 performs processing of adding teaching material data. Thereafter, the process returns to step S207. Specifically, the processor 11 requests, for example, the server 20 to transmit the teaching material data corresponding to the add button 168 selected by the user. The request to add the teaching material data may be made after the fee is completely paid by the user. In addition, the additional teaching material data may not be necessarily stored in the server 20. In this case, the processor 11 requests the storage destination in which the corresponding teaching material data is stored to transmit the teaching material data. After receiving the additional teaching material data, the processor 11 stores the received teaching material data to the storage 14 as new teaching material data 142. Thereafter, the process returns to step S207.

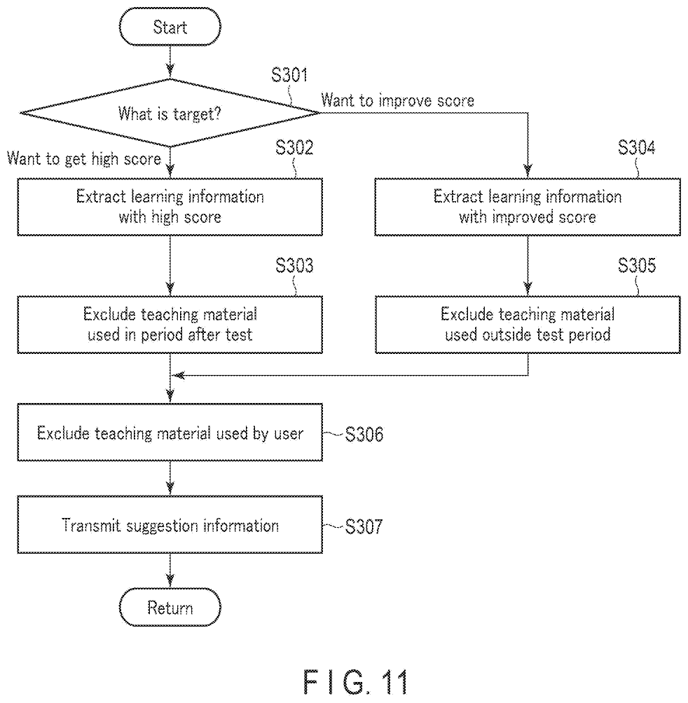

FIG. 11 is a flowchart illustrating the teaching material extraction process. In step S301, the processor 21 of the server 20 starts processing of suggesting the teaching material data to be recommended based on the suggestion request received from the electronic dictionary 10 of the user. Specifically, based on the information included in the suggestion request, it is determined whether the target selected by the user is “want to get a high score” or “want to improve the score”. In a case where it is determined in step S301 that the target selected by the user is “want to get a high score”, the process proceeds to step S302. In a case where it is determined in step S301 that the target selected by the user is “want to improve the score”, the process proceeds to step S304.

In step S302, the processor 21 extracts learning information with a high test score equal to or higher than a reference score from among learning information 244 of a subject selected by the user. In a case where a test of the subject selected by the user is a test 1 and a reference value for a high score is, for example, 90 points or more, the processor 21 extracts learning information in which a result of the test 1 is 90 points or more. For example, in a case where the learning information illustrated in FIG. 4 is stored in the storage 24, the processor 21 extracts the learning information 1 in which the result of the test 1 is 90 points as learning information with a high test score. On the other hand, in each of the learning information 2 in which a result of the test 1 is 70 points and the learning information 3 in which a result of the test 1 is 50 points, the score of the test is less than 90 points which is the reference score. Therefore, the processor 21 does not extract the learning information 2 and the learning information 3 as the learning information with a high score. On the other hand, in a case where the reference value for the high score is, for example, 70 points or more, the processor 21 extracts learning information in which a result of the test is 70 points or more. In this case, for example, in a case where the learning information illustrated in FIG. 4 is stored in the storage 24, the processor 21 extracts the learning information 1 in which the result of the test 1 is 90 points and the learning information 2 in which the result of the test 1 is 70 points as the learning information with a high score, but does not extract the learning information 3 in which the result of the test 1 is 50 points as the learning information with a high score. The reference value for the high score is set in advance in the server 20. The reference value for the high score may be designated by the user. Furthermore, in a case where the suggestion request also includes information of a learning item, the processor 11 may extract learning information based on a score of the learning item selected by the user.

In step S303, the processor 21 excludes information of a teaching material used in a period after the test from the extracted learning information. Thereafter, the process proceeds to step S306. For example, in the learning information 1, the execution date of the test 1 is Jan. 6, 2022. Therefore, the processor 21 excludes information with an activation date of Jan. 7, 2022 from the extracted learning information 1. In other words, the processor 21 extracts information in which an activation date is earlier than the execution date of the test 1. This is because it is unclear whether teaching material data used after the test is teaching material data contributing to a high score. Note that, even if the activation date is earlier than the execution date of the test 1, teaching material data whose latest activation date is a predetermined period (for example, one month) before the execution date of the test 1 is excluded from data to be extracted. This is because it is unclear whether teaching material data whose activation date is too old contributes to a high score of the test.

In step S304, the processor 21 extracts learning information with an improved test score from among the learning information 244 of the subject selected by the user. In a case where the test of the subject selected by the user is the test 1, the processor 21 extracts learning information in which the score of the test 1 is improved. For example, in a case where the learning information illustrated in FIG. 4 is stored in the storage 24, the processor 21 extracts the learning information 2 in which the result of the test 1 is improved from 50 points to 70 points as the learning information with an improved test score. On the other hand, the processor 21 does not extract the learning information 1 in which the test 1 is not executed a plurality of times and the learning information 3 in which the result of the test 1 is not improved from 50 points as the learning information with an improved test score. In this case, a reference value for an improvement amount of the score may be set in advance in the server 20. That is, learning information in which the improvement amount of the score is less than the reference value may not be extracted. The reference value for the improvement amount of the score may be designated by the user. Furthermore, in a case where the suggestion request also includes information of the learning item, the processor 11 may extract learning information based on a score of the learning item selected by the user.

In step S305, the processor 21 excludes information of a teaching material used outside a test period between the previous test and the next test from the extracted learning information. Thereafter, the process proceeds to step S306. For example, in the learning information 2, the execution date of the first test 1 is Jan. 4, 2022, and the execution date of the second test 1 is Jan. 8, 2022. Therefore, the processor 21 excludes information with the activation date of Jan. 2, 2022 and information with the activation date of Jan. 3, 2022 from the extracted learning information 2. In other words, the processor 21 extracts information in which an activation date is later than the execution date of the first test 1 and earlier than the execution date of the second test 1. This is because it is unclear whether the teaching material data used outside the test period is teaching material data that contributed to the improvement of the score.

In step S306, the processor 21 refers to the electronic dictionary 10 that transmitted the suggestion request or the learning information of the user of the electronic dictionary 10, and excludes information of a teaching material used by the user from the extracted learning information. For example, in a case where the learning information of the user of the electronic dictionary 10 is the learning information 3, the processor 21 excludes information of a “teaching material C”, a “teaching material D”, and a “teaching material E” from the extracted learning information. This is because there is a possibility that the teaching material used by the user does not contribute to acquisition of a high score or improvement of the score for the user.

In step S307, the processor 21 transmits suggestion information to the electronic dictionary 10 that transmitted the suggestion request. Thereafter, the process illustrated in FIG. 11 ends. The suggestion information includes information for specifying teaching material data remaining without being excluded from the extracted learning information. For example, in a case where “want to get a high score” is designated as the target of learning, the test of the subject selected by the user is the test 1, and the reference value for the high score is, for example, 90 points or more, the processor 21 extracts the learning information 1 as described above. In this case, the suggestion information includes information for specifying each of the “teaching material A” and the “teaching material B”. The information for specifying the teaching material data may be a name, an ID, or the like of the teaching material data. According to such suggestion information, the suggestion screen illustrated in FIG. 10 can be displayed in the electronic dictionary 10.

As described above, according to the present embodiment, information of teaching material data useful for learning by the user is output as the suggestion information based on learning information collected from the plurality of electronic dictionaries 10. In this case, the information of the teaching material data is extracted based on not only a test score but also a test execution date. As a result, information of teaching material data that is considered not to contribute to the improvement of the academic ability can be efficiently excluded. Therefore, there is a high possibility that information of teaching material data useful for learning by the user is extracted. The suggestion of the information of the teaching material data to the user is useful for the user to determine which teaching material data among data of many teaching materials is useful for the user's own learning.

Furthermore, the extraction of the information of the teaching material data is also performed based on the learning target designated by the user. As a result, the possibility that the information of the teaching material data that further meets the user's target is extracted is increased. Note that, the embodiments describe the extraction of information of teaching material data based on the two learning targets of “want to improve the score” and “want to get a high score”. It is needless to say that information of teaching material data conforming to each learning target is extracted for other learning targets.

### MODIFICATIONS

Hereinafter, modifications of the embodiments will be described.

FIG. 4 illustrates an example in which only three pieces of learning information are stored in the storage 24 of the server 20. In practice, a number of pieces of learning information collected from more electronic dictionaries 10 may be stored in the storage 24. In this case, there is a possibility that learning information including teaching material information in which a score of a test is high or a score is improved is extracted only in a case where a specific user uses the learning information. Such information of a teaching material that improves the academic ability only in a case where the specific user uses the teaching material may not be included in the suggestion information. That is, processing of excluding information of a teaching material of which the number of times of use among all the users is less than a threshold value may be added to the processing illustrated in FIG. 11. Of course, since there is also a case where information of a teaching material that improves the academic ability only in a case where a specific user uses the teaching material is useful, the processing of excluding information of a teaching material of which the number of times of use among all the users is less than the threshold value in this manner may not be added to the processing illustrated in FIG. 11.

In addition, in the above-described embodiments, the learning information stored in the storage 24 of the server 20 is collected from the electronic dictionaries 10. On the other hand, as long as the learning information is associated with the user information, the learning information may not be necessarily collected from the electronic dictionaries 10. For example, a result of a test executed in an environment other than the electronic dictionaries 10 may be transmitted to the server 20 as learning information associated with the IDs of the users or the like. Furthermore, the learning information may be manually input. In this case, the test is not necessarily executed using an electronic device, and may be executed using, for example, a paper sheet.

Further, in the above-described embodiments, the suggestion screen is displayed on the display device 16 of the electronic dictionary 10. However, the suggestion screen may not be necessarily displayed on the display device 16 of the electronic dictionary 10. For example, the suggestion screen illustrated in FIG. 10 may be displayed on a screen of an online shop browsed by a user who is considering purchase of an electronic dictionary using an electronic device such as a smartphone. In this case, the user determines whether or not to add suggested teaching material data to the electronic dictionary being considered for purchase, and can add the teaching material data as necessary. In this way, the embodiments may also be applied to online sales of electronic dictionaries 10 having a custom function.

Furthermore, in the above-described embodiments, the information of the teaching material data useful for the learning by the user is generated in the server 20. On the other hand, the generation of the suggestion information and the display of the suggestion screen may be performed in the electronic dictionary 10. In this case, the electronic dictionary 10 operates as an information processing apparatus. In this case, even in a case where the electronic dictionaries 10 extract information of teaching material data, the collection of the learning information from the plurality of electronic dictionaries 10 may be performed by the server 20.

Note that the present invention is not limited to the above embodiments, and various modifications can be made in the implementation stage without departing from the gist of the present invention. In addition, each embodiment may be implemented by appropriately combining the embodiments as much as possible, and in that case, a combined effect can be obtained. Furthermore, the above-described embodiments include inventions at various stages, and various inventions can be extracted by an appropriate combination of a plurality of disclosed constituent elements. For example, in a case where the problems described in the section of the problem to be solved by the invention can be solved and the effect described in the section of the effect of the invention can be obtained even if some components are removed from all the components described in the embodiments, the configuration from which the components are removed can be extracted as the invention.

What is claimed is:

1. An information processing apparatus comprising a processor configured to:
acquire first history information and second history information from a storage unit that stores learning information on a plurality of users, the learning information being information for specifying an activation date of teaching material data and the teaching material data for the plurality of users as the first history information, and information for specifying an execution date of a test and the test and results of the test for the plurality of users as the second history information;
extract, from the learning information stored in the storage unit, learning information in which a result of the test satisfies a predetermined condition and in which an activation date of teaching material data is earlier than the execution date of the test, based on the acquired first history information and the acquired second history information; and
output information for specifying the teaching material data, included in the extracted learning information.

2. The information processing apparatus according to claim 1, wherein
the predetermined condition is that a score of the test is greater than or equal to a reference value, and
the processor extracts, from the learning information stored in the storage unit, learning information in which the activation date of the teaching material data is earlier than an execution date of a test for which a score is equal to or greater than the reference value, based on second history information included in the acquired second history information and including the execution date of the test for which the score is equal to or greater than the reference value as a result of the test.

3. The information processing apparatus according to claim 1, wherein
the processor extracts, from the learning information stored in the storage unit, learning information in which a result of the test satisfies the predetermined condition and in which the activation date of the teaching material data is earlier than the execution date of the test in which the result of the test satisfies the predetermined condition, and is within a predetermined period from the execution date of the test in which the result of the test satisfies the predetermined condition.

4. The information processing apparatus according to claim 1, wherein
the predetermined condition is that a score of the test is higher than a score of a previous test, and
the processor extracts, from the learning information stored in the storage unit, learning information in which the score of the test is higher than the score of the previous test and in which the activation date of the teaching material data is earlier than the execution date of the test and later than the execution date of the previous test.

5. The information processing apparatus according to claim 1, wherein
the processor outputs the information for specifying the teaching material data to an electronic device that made a request.

6. An information output method executed by an information processing apparatus, the method comprising:
acquiring first history information and second history information from a storage unit that stores learning information on a plurality of users, the learning information being information for specifying an activation date of teaching material data and the teaching material data for the plurality of users as the first history information, and information for specifying an execution date of a test and the test and results of the test for the plurality of users as the second history information;
extracting, from the learning information stored in the storage unit, learning information in which a result of the test satisfies a predetermined condition and in which the activation date of teaching material data is earlier than the execution date of the test, based on the acquired first history information and the acquired second history information; and
outputting information for specifying the teaching material data, the information being included in the extracted learning information.

7. The information output method according to claim 6, wherein
the predetermined condition is that a score of the test is greater than or equal to a reference value, and
the extracting extracts, from the learning information stored in the storage unit, learning information in which the activation date of the teaching material data is earlier than the execution date of a test for which a score is equal to or greater than the reference value, based on second history information included in the acquired second history information and including the execution date of the test for which the score is equal to or greater than the reference value as a result of the test.

8. The information output method according to claim 6, wherein
the extracting extracts, from the learning information stored in the storage unit, learning information in which the result of the test satisfies the predetermined condition and in which the activation date of the teaching material data is earlier than the execution date of the test in which the result of the test satisfies the predetermined condition, and is within a predetermined period from the execution date of the test in which the result of the test satisfies the predetermined condition.

9. The information output method according to claim 6, wherein
the predetermined condition is that a score of the test is higher than a score of a previous test, and
the extracting extracts, from the learning information stored in the storage unit, learning information in which the score of the test is higher than the score of the previous test and in which the activation date of the teaching material data is earlier than the execution date of the test and later than an execution date of the previous test.

10. The information output method according to claim 6, wherein
the outputting outputs the information for specifying the teaching material data to an electronic device that made a request.

11. A non-transitory recording medium having recorded therein a program for causing a computer to execute:
acquiring first history information and second history information from a storage unit that stores learning information on a plurality of users, the learning information being information for specifying an activation date of teaching material data and the teaching material data for the plurality of users as the first history information, and information for specifying an execution date of a test and the test and results of the test for the plurality of users as the second history information;
extracting, from the learning information stored in the storage unit, learning information in which a result of the test satisfies a predetermined condition and in which the activation date of teaching material data is earlier than the execution date of the test, based on the acquired first history information and the acquired second history information; and
outputting information for specifying the teaching material data, the information being included in the extracted learning information.

12. The recording medium according to claim 11, wherein
the predetermined condition is that a score of the test is greater than or equal to a reference value, and
the extracting extracts, from the learning information stored in the storage unit, learning information in which the activation date of the teaching material data is earlier than an execution date of a test for which a score is equal to or greater than the reference value, based on second history information included in the acquired second history information and including the execution date of the test for which the score is equal to or greater than the reference value as a result of the test.

13. The recording medium according to claim 11, wherein
the extracting extracts, from the learning information stored in the storage unit, learning information in which a result of the test satisfies the predetermined condition and in which the activation date of the teaching material data is earlier than the execution date of the test in which the result of the test satisfies the predetermined condition, and is within a predetermined period from the execution date of the test in which the result of the test satisfies the predetermined condition.

14. The recording medium according to claim 11, wherein
the predetermined condition is that a score of the test is higher than a score of a previous test, and
the extracting extracts, from the learning information stored in the storage unit, learning information in which the score of the test is higher than the score of the previous test and in which the activation date of the teaching material data is earlier than the execution date of the test and later than the execution date of the previous test.

15. The recording medium according to claim 11, wherein
the outputting outputs the information for specifying the teaching material data to an electronic device that made a request.
